(19) United States
(12) Patent Application Publication
(10) Pub. No.: US 2022/0225823 A1
(43) Pub. Date: Jul. 21, 2022

(54) Lids for cooking or warming pans

(71) Applicant: Nicole Culbreth, Henrico, VA (US)

(72) Inventor: Nicole Culbreth, Henrico, VA (US)

(21) Appl. No.: 17/150,419

(22) Filed: Jan. 15, 2021

(51) Int. Cl. A47J 36/06

(52) U.S. Cl. CPC A47J 36/06

(57) ABSTRACT

Disclosed is a device that is used to cover a typical aluminum pan and to allow easy access to the contents within the pan.

### PREVIOUSLY FILED APPLICATION

This application claims priority to provisional application No. 62/961,608 filed on Jan. 15, 2020, whose disclosure is hereby incorporated by reference in its entirety into the present disclosure.

### BACKGROUND OF THE DISCLOSURE FIELD OF THE INVENTION

The field of this disclosure generally relates to cookware, and more specifically, to lids for warming pans and baking pans.

### DESCRIPTION OF THE RELATED ART

Pans used, for example, for events, parties and gatherings can include aluminum pans although other materials used for food and cooking pans can also be used. Typically, to preserve the food during an event, aluminum foil is placed over a pan containing food. Aluminum foil is easy to use and can effectively cover food stored in a pan. On the other hand, an aluminum foil covering can become ragged, torn, and worn out after as little as a few, e.g. 4-6, uses. This then requires changing the aluminum foil frequently throughout the event. Covering is generally necessary to preserve food from bugs, flies, or anything else that may make it into the food and contaminate the food. Plastic lids that sometimes come with the pans are generally flimsy in character, cannot be well secured to the aluminum pan, and frequently cannot be easily returned to the pan after removal.

### SUMMARY OF THE INVENTION

The present disclosure relates to lids for food cooking and heating pans, including aluminum pans, to secure the food no matter how many times food is taken from the pan. The lids may preferably be made of polycarbonate which allows them to be warmed in an oven with the pan. The lids are reusable, easy to clean, and have multiple openings, for example two openings, to allow access to the food without exposing all of the food in the pan. They may be clear or opaque in color to allow visual observation of the food in the pan.

Other features and aspects will be apparent from the following detailed description, the figures, and the claims.

### BRIEF DESCRIPTION OF THE DRAWINGS

FIG. 1 is a top view of the device.

FIG. 2 is a side view of the device on a pan.

FIG. 3 is a perspective view of the device with open lids on a pan.

FIGS. 4A, 4B, 4C, and 4D are close up views of the center section of the lid securing voids.

FIGS. 5A, 5B, 5C, and 5D are close of views of the center section of the lid hinges.

FIG. 6 is a side, close up view, of the lid attaching to an aluminum pan.

### DETAILED DESCRIPTION

The following detailed description is provided to assist the reader in gaining a comprehensive understanding of the methods, products, and/or systems, described herein. However, various changes, modifications, and equivalents of the methods, products, and/or systems described herein will be apparent to an ordinary skilled artisan.

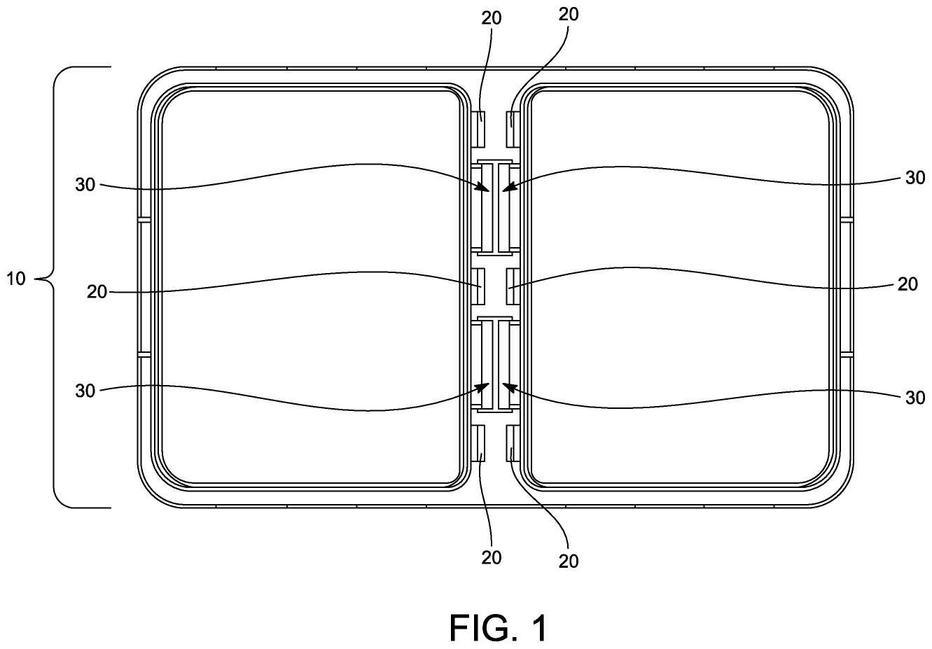

FIG. 1 shows an example of a rectangular lid, 10, of the present disclosure. As exemplified in FIG. 1, the lid, 10, may include at least one hinge slot, 20, and at least one recessed securing void or cavity, 30. The lid, 10, may also include one or more handles, and regions for the placement of a label. It may be made of an opaque polycarbonate material, metal, plastic, polymer, or other material as needed or desired.

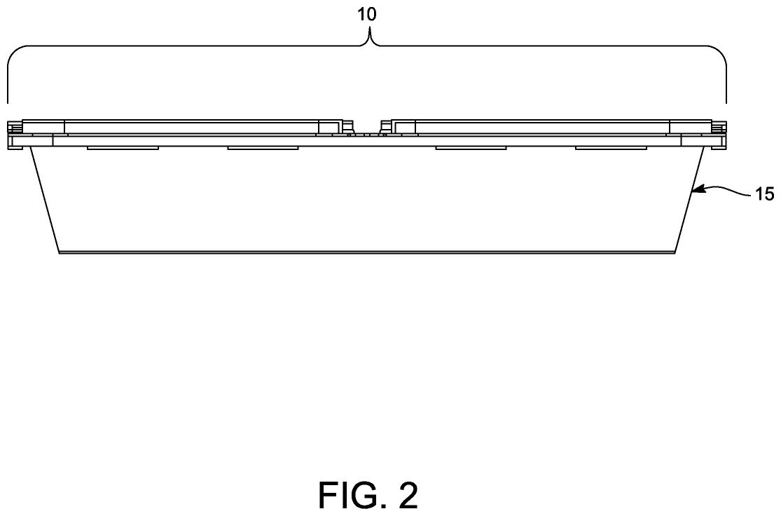

FIG. 2 shows the lid, 10, on a pan, 15. As shown in FIG. 2, the lid may include a lid rim rest with hinged covers. The lid rim rest may rest on top of a pan and provide for a fixed connection to the pan. Access to the pan may then be gained through the lid cover openings with the rim remaining fixed to the pan.

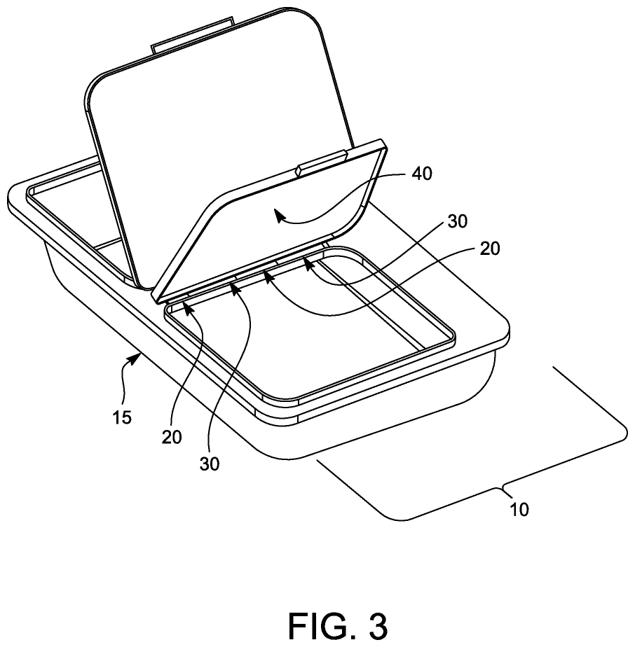

FIG. 3 shows a lid, 10, on a pan, 15, wherein the lid, 10, has at least one liftable section, 40, that can be lifted up to allow access to the contents within the pan, 15. The liftable sections of the lid, 10, are attached to the lid, 10, via a set of at least one hinge slot, 20. The hinge slots, 20, are designed such that the liftable sections, 40, of the lid, 10, can be lifted to uncover, and allow access to, the contents of the pan, 15.

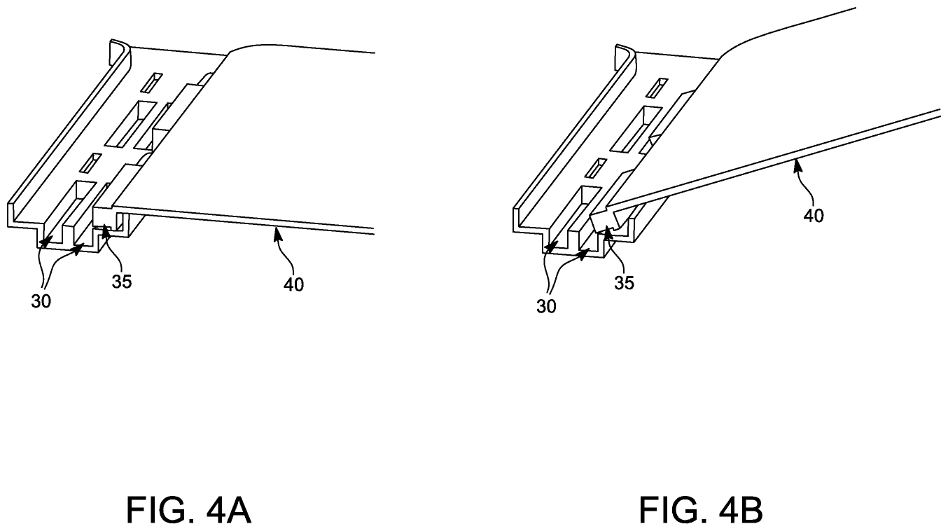

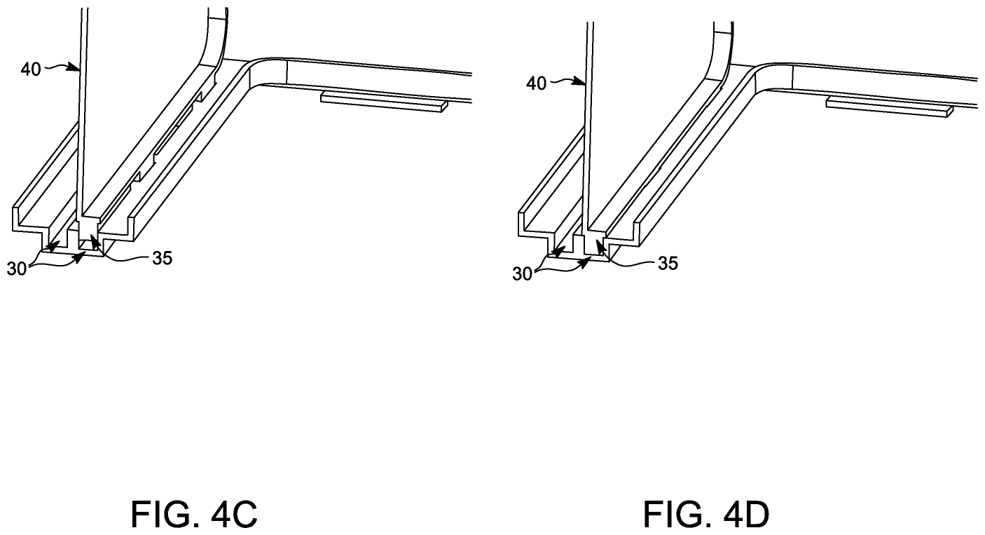

FIGS. 4A, 4B, 4C, and 4D shows the operation of the recessed securing void or cavity, 30, in conjunction with the liftable section, 40, wherein the liftable section, 40, has at least one attached securing block, 35. As shown in FIGS. 4A, 4B, 4C, and 4D the securing block, 35, is not engaged with the recessed securing void or cavity 30, until and unless the lid, 40, is moved to a vertical position relative to the center section of the lid, 10. Once in the vertical position, as shown by FIGS. 4C and 4D, the securing block, 35, can be inserted into the recessed securing void or cavity, 30, thereby providing support to the liftable section, 40, to allow it to remain vertical without additional applied force. Alternative, the securing block, 35, and recessed securing void or cavity, 30, may be designed to allow the liftable lid, to be secured at any desired angle.

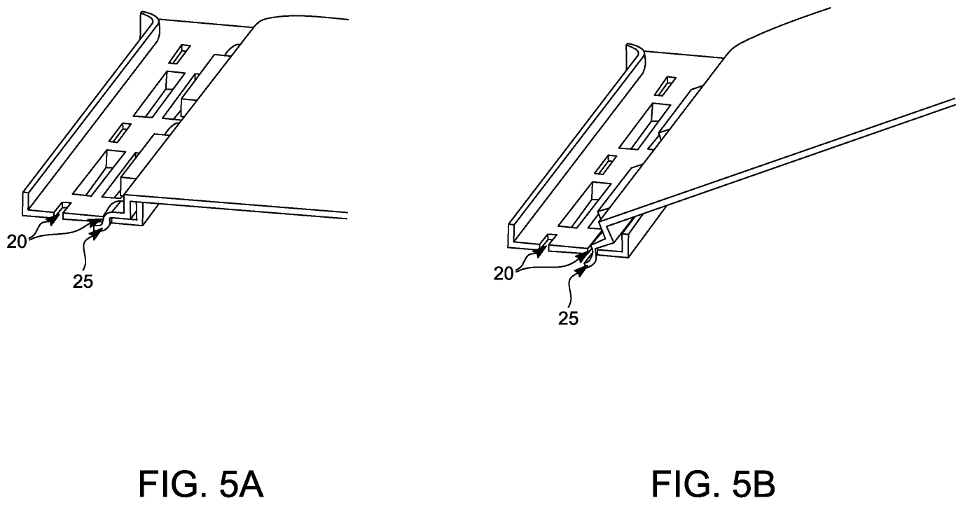

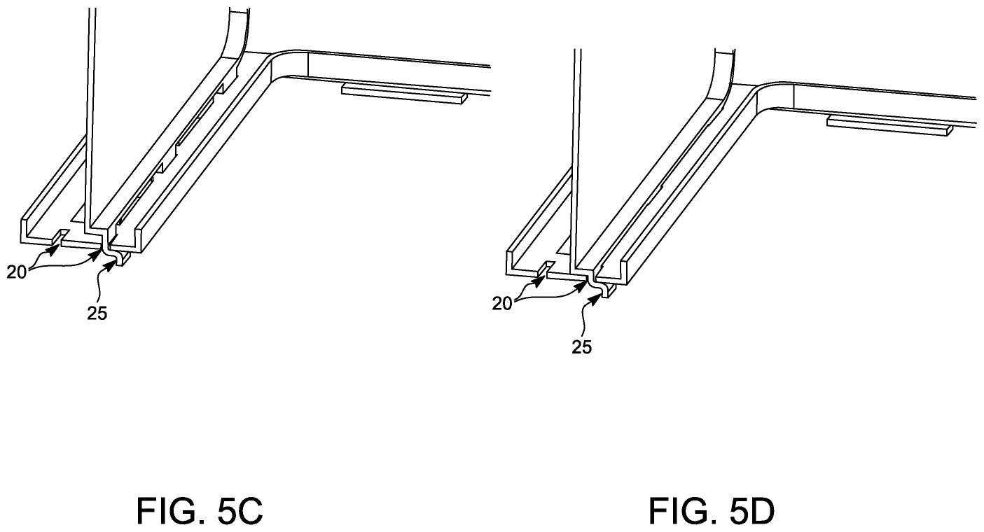

FIGS. 5A, 5B, 5C, and 5D shows the operation of the hinge slots, 20, in conjunction with the hinge attachment mechanism, 25. The hinge attachment mechanism, 25, is shown in a “S” shaped design. However, any other design, such as “L”, hook, or other design may be used as long as the hinge slots are designed to mesh with the hinge attachment mechanism. The hinge attachment mechanisms, 25, are further designed to be able to recess into the pan, below the center portion of the lid, so as to allow, assist, and support the liftable section, 40, of the lid.

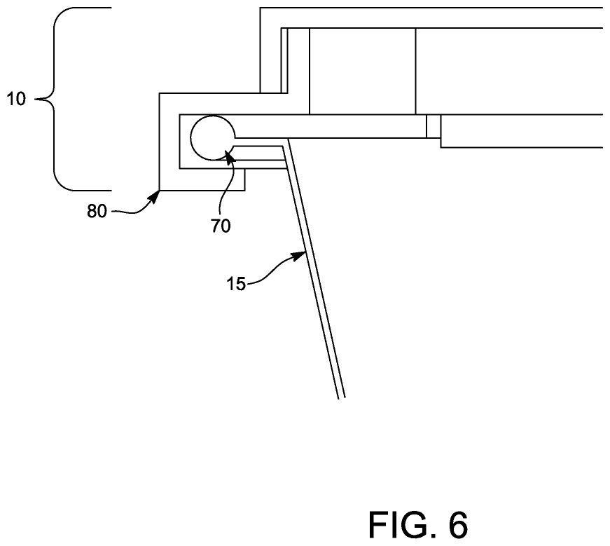

FIG. 6 shows the edge of the aluminum pan, 15, and the edge of lid, 10. The edge of the lid, 10, has a rim, 80, that is made to fit over and be secured by the edge, 70, of the aluminum pan. This allows the lid, 10, to be attached firmly to the aluminum pan, 15, and minimize the changes of the lid, 10, being inadvertently removed from the aluminum pan, 15.

The rim rest may be made of the same or different plastic or polycarbonate material as the cover(s). The rim rest may or may not be clear or opaque. The rim rest may be generally made of any suitable material known in the cooking pan art.

While polycarbonate is a preferred material, other suitable plastics, composites, or other like materials that are heat resistant to temperatures suitable for warming food and optionally opaque or clear are contemplated.

Furthermore, the lids may also have other designs with one or more openings for different shaped pans. The lids may also be of a variety of sizes. For example, a circular pan may have several openings. A larger rectangular shaped pan may have more openings. The shape of the rim and the number of openings can thus be varied to suit the particular pan. All shapes and sizes of pans generally known in the art for holding food at home or events, parties, etc. are contemplated.

While this disclosure includes specific examples, it will be apparent after an understanding of the disclosure of this application has been attained that various changes in form and details may be made in these examples without departing from the spirit and scope of the claims and their equivalents.

We claim:

1. A device comprising:
a rim capable of being fixedly attached to a second device wherein said rim has a at least one hinge attachment point and at least one cavity;
at least one removable and liftable lid wherein said removeable and liftable lid can essentially cover the entire second device and the removeable and liftable lid has at least one hinge assembly and one securing block attached to said removeable and liftable lid wherein said removeable and liftable lid can be completely removed from said rim.

2. The device of claim 1 wherein said rim and lid are manufactured from the same or different materials.

3. The device of claim 1 wherein the lid and rim are made from plastics, polymers, metals or wood.
